(19) United States
(12) Patent Application Publication
(10) Pub. No.: US 2025/0139737 A1
(43) Pub. Date: May 1, 2025

(54) SIGNALING OF SENSOR SPECIFIC RAW IMAGE MASK

(71) Applicant: QUALCOMM Incorporated, San Diego, CA (US)

(72) Inventors: David YUNUSOV, Holon (IL); Gideon Shlomo KUTZ, Ramat Hasharon (IL); Assaf TOUBOUL, Netanya (IL); Amit BAR-OR TILLINGER, Tel-Aviv (IL)

(21) Appl. No.: 18/496,753

(22) Filed: Oct. 27, 2023

(51) Int. Cl. G06T 3/40; G06T 9/00

(52) U.S. Cl. CPC G06T 3/4015; G06T 3/4038; G06T 9/00

(57) ABSTRACT

Methods, systems, and devices for wireless communications are described. A first network entity may receive control signaling from a second network entity, the control signaling indicating an image mask representing a color filter array that is used to generate mosaic images at the second network entity. The first network entity may receive a first image from the second network entity over a wireless communications channel and the first image may be a single layer image including a mosaic pattern according to the color filter array. The first network entity may generate a second image based on the first image and the image mask and the second image may include multiple layers associated with colors of the second image.

### FIELD OF TECHNOLOGY

The following relates to wireless communications, including signaling of sensor specific raw image mask.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a wireless device may capture an image and transmit the image to another device. However, challenges may exist in transmission of image data efficiently over wireless channel.

### SUMMARY

The described techniques relate to improved methods, systems, devices, and apparatuses that support signaling of sensor specific raw image mask. For example, a first network entity (e.g., a gNB, base station, a user equipment (UE), or other network entity) may receive control signaling from a second network entity (e.g., a gNB, base station, a user equipment (UE), or other network entity), the control signaling indicating an image mask representing a color filter array that is used to generate mosaic images at the second network entity. The first network entity may receive a first image from the second network entity over a wireless communications channel and the first image may be a single layer image including a mosaic pattern according to the color filter array. The first network entity may generate a second image based on the first image and the image mask and the second image may include multiple layers associated with colors of the second image.

A method for wireless communications by an apparatus is described. The method may include receiving, at a first network entity, control signaling from a second network entity, the control signaling indicating an image mask representing a color filter array that is used to generate mosaic images at the second network entity, receiving a first image at the first network entity from the second network entity over a wireless communications channel, where the first image is a single layer image including a mosaic pattern according to the color filter array, and generating, at the first network entity, a second image based on the first image and the image mask, where the second image includes multiple layers associated with colors of the second image.

An apparatus for wireless communications is described. The apparatus may include one or more memories storing processor executable code, and one or more processors coupled with the one or more memories. The one or more processors may individually or collectively operable to execute the code to cause the apparatus to receive, at a first network entity, control signaling from a second network entity, the control signaling indicating an image mask representing a color filter array that is used to generate mosaic images at the second network entity, receive a first image at the first network entity from the second network entity over a wireless communications channel, where the first image is a single layer image including a mosaic pattern according to the color filter array, and generate, at the first network entity, a second image based on the first image and the image mask, where the second image includes multiple layers associated with colors of the second image.

Another apparatus for wireless communications is described. The apparatus may include means for receiving, at a first network entity, control signaling from a second network entity, the control signaling indicating an image mask representing a color filter array that is used to generate mosaic images at the second network entity, means for receiving a first image at the first network entity from the second network entity over a wireless communications channel, where the first image is a single layer image including a mosaic pattern according to the color filter array, and means for generating, at the first network entity, a second image based on the first image and the image mask, where the second image includes multiple layers associated with colors of the second image.

A non-transitory computer-readable medium storing code for wireless communications is described. The code may include instructions executable by a processor to receive, at a first network entity, control signaling from a second network entity, the control signaling indicating an image mask representing a color filter array that is used to generate mosaic images at the second network entity, receive a first image at the first network entity from the second network entity over a wireless communications channel, where the first image is a single layer image including a mosaic pattern according to the color filter array, and generate, at the first network entity, a second image based on the first image and the image mask, where the second image includes multiple layers associated with colors of the second image.

Some examples of the method, apparatus, and non-transitory computer-readable medium described herein may further include operations, features, means, or instructions for generating the second image includes applying, to the first image, a demosaicing filter that corresponds to the image mask to interpolate multiple layers of the second image from the first image.

In some examples of the method, apparatus, and non-transitory computer-readable medium described herein, the second image may be generated at a physical layer of the first network entity.

Some examples of the method, apparatus, and non-transitory computer-readable medium described herein may further include operations, features, means, or instructions for receiving the control signaling indicating the image mask includes receiving a pattern of colors associated with the color filter array.

Some examples of the method, apparatus, and non-transitory computer-readable medium described herein may further include operations, features, means, or instructions for receiving the control signaling indicating the image mask includes receiving an index associated with the color filter array selected from a set of multiple indices associated with a set of multiple color filter arrays.

Some examples of the method, apparatus, and non-transitory computer-readable medium described herein may further include operations, features, means, or instructions for receiving an indication of the set of multiple indices associated with the set of multiple color filter arrays.

Some examples of the method, apparatus, and non-transitory computer-readable medium described herein may further include operations, features, means, or instructions for transmitting, to the second network entity, the second image or a second mosaic image based on the second image.

In some examples of the method, apparatus, and non-transitory computer-readable medium described herein, the first image may be a compressed image; the method further including decompressing the first image at the first network entity.

In some examples of the method, apparatus, and non-transitory computer-readable medium described herein, the control signaling may be received in response to establishing a connection between the first network entity and the second network entity.

In some examples of the method, apparatus, and non-transitory computer-readable medium described herein, the first image may be a single layer image.

In some examples of the method, apparatus, and non-transitory computer-readable medium described herein, the control signaling may be radio resource control (RRC) signaling, uplink control information (UCI) signaling, downlink control information (DCI) signaling, sidelink control information (SCI) signaling, or any combination thereof.

A method for wireless communications by an apparatus is described. The method may include transmitting, from a first network entity to a second network entity, control signaling indicating an image mask representing a color filter array that is used to generate mosaic images at the first network entity and transmitting a first image from the first network entity to the second network entity over a wireless communications channel, where the first image is a single layer image including a mosaic pattern according to the color filter array.

An apparatus for wireless communications is described. The apparatus may include one or more memories storing processor executable code, and one or more processors coupled with the one or more memories. The one or more processors may individually or collectively operable to execute the code to cause the apparatus to transmit, from a first network entity to a second network entity, control signaling indicating an image mask representing a color filter array that is used to generate mosaic images at the first network entity and transmit a first image from the first network entity to the second network entity over a wireless communications channel, where the first image is a single layer image including a mosaic pattern according to the color filter array.

Another apparatus for wireless communications is described. The apparatus may include means for transmitting, from a first network entity to a second network entity, control signaling indicating an image mask representing a color filter array that is used to generate mosaic images at the first network entity and means for transmitting a first image from the first network entity to the second network entity over a wireless communications channel, where the first image is a single layer image including a mosaic pattern according to the color filter array.

A non-transitory computer-readable medium storing code for wireless communications is described. The code may include instructions executable by a processor to transmit, from a first network entity to a second network entity, control signaling indicating an image mask representing a color filter array that is used to generate mosaic images at the first network entity and transmit a first image from the first network entity to the second network entity over a wireless communications channel, where the first image is a single layer image including a mosaic pattern according to the color filter array.

Some examples of the method, apparatus, and non-transitory computer-readable medium described herein may further include operations, features, means, or instructions for transmitting the control signaling indicating the image mask includes transmitting a pattern of colors associated with the color filter array.

Some examples of the method, apparatus, and non-transitory computer-readable medium described herein may further include operations, features, means, or instructions for transmitting the control signaling indicating the image mask includes transmitting an index associated with the color filter array selected from a set of multiple indices associated with a set of multiple color filter arrays.

Some examples of the method, apparatus, and non-transitory computer-readable medium described herein may further include operations, features, means, or instructions for transmitting an indication of the set of multiple indices associated with the set of multiple color filter arrays.

Some examples of the method, apparatus, and non-transitory computer-readable medium described herein may further include operations, features, means, or instructions for receiving a second image from the second network entity, the second image generated based on the first image and the image mask, and the second image including multiple layers associated with colors of the second image or a second mosaic image.

Some examples of the method, apparatus, and non-transitory computer-readable medium described herein may further include operations, features, means, or instructions for compressing the first image.

In some examples of the method, apparatus, and non-transitory computer-readable medium described herein, the control signaling may be transmitted in response to establishing a connection between the first network entity and the second network entity.

In some examples of the method, apparatus, and non-transitory computer-readable medium described herein, the first image may be a single layer image.

In some examples of the method, apparatus, and non-transitory computer-readable medium described herein, the control signaling may be RRC signaling, uplink control information signaling, downlink control information signaling, sidelink control information signaling, or any combination there.

### BRIEF DESCRIPTION OF THE DRAWINGS

FIG. 1 shows an example of a wireless communications system that supports signaling of sensor specific raw image mask in accordance with one or more examples as disclosed herein.

FIG. 2 shows an example of an image communications scheme that supports signaling of sensor specific raw image mask in accordance with one or more examples as disclosed herein.

FIG. 3 shows an example of a wireless communications system that supports signaling of sensor specific raw image mask in accordance with one or more examples as disclosed herein.

FIG. 4 shows an example of an image communications scheme that supports signaling of sensor specific raw image mask in accordance with one or more examples as disclosed herein.

FIG. 5 shows an example of a process flow that supports signaling of sensor specific raw image mask in accordance with one or more examples as disclosed herein.

FIGS. 6 and 7 show block diagrams of devices that support signaling of sensor specific raw image mask in accordance with one or more examples as disclosed herein.

FIG. 8 shows a block diagram of a communications manager that supports signaling of sensor specific raw image mask in accordance with one or more examples as disclosed herein.

FIG. 9 shows a diagram of a system including a device that supports signaling of sensor specific raw image mask in accordance with one or more examples as disclosed herein.

FIGS. 10 and 11 show flowcharts illustrating methods that support signaling of sensor specific raw image mask in accordance with one or more examples as disclosed herein.

### DETAILED DESCRIPTION

The operation of many wireless communication devices involve image capture (e.g., for still images or video). Such devices may capture an image using a color filter array (CFA) that uses a pattern of color filters to capture certain wavelengths of light at certain pixels, creating a mosaic image. In the mosaic image, each pixel may include a value for the strength of the wavelength of light captured for that pixel and the image may be a single layer image. In some approaches, the device that captures the image performs a demosaicing operation to interpolate color values (e.g., RGB values) for multiple colors to produce a final output image (e.g., which may be a multi-layer image, such as an RGB image that may include a layer each for red, green, and blue values), which may then be transmitted to another device. However, such processing at the capturing device may be resource intensive, particularly when a device that captures the image may be a reduced complexity device that involves power considerations, processing resource considerations, storage considerations, or any combination thereof.

According to various aspects, to mitigate such issues, a first device that captures an image may transmit a raw, mosaic image (or an image to which one or more compression or other processing techniques have been applied to reduce communications overhead, for example) for demosaicing to be performed at the receiving device. For example, the first device may capture the image using a CFA and may generate the raw, mosaic image. The first device may transmit the raw, mosaic image to a second device that may perform the processing to demosaic the image or perform other processing to generate a final, multi-layer image (e.g., an RGB image including a layer each for red, green, and blue values). The first device may also transmit signaling to the second device that may indicate the CFA that was used to generate the mosaic image so that the second device may properly process (e.g., through demosaicing, decompression, one or more other image processing techniques, or any combination thereof). For example, the first device may transmit a mosaic pattern or an index associated with a mosaic pattern from which the second device may identify the CFA used and apply the appropriate demosaicing algorithm. In this way, the techniques and devices described herein offer reduced complexity at the transmitting device (e.g., reduced processing/memory requirements), reduced latency, increased quality, or any combination thereof.

Aspects of the disclosure are initially described in the context of wireless communications systems. Aspects of the disclosure are then described with reference to image communications schemes, a wireless communications system, and a process flow. Aspects of the disclosure are further illustrated by and described with reference to apparatus diagrams, system diagrams, and flowcharts that relate to signaling of sensor specific raw image mask.

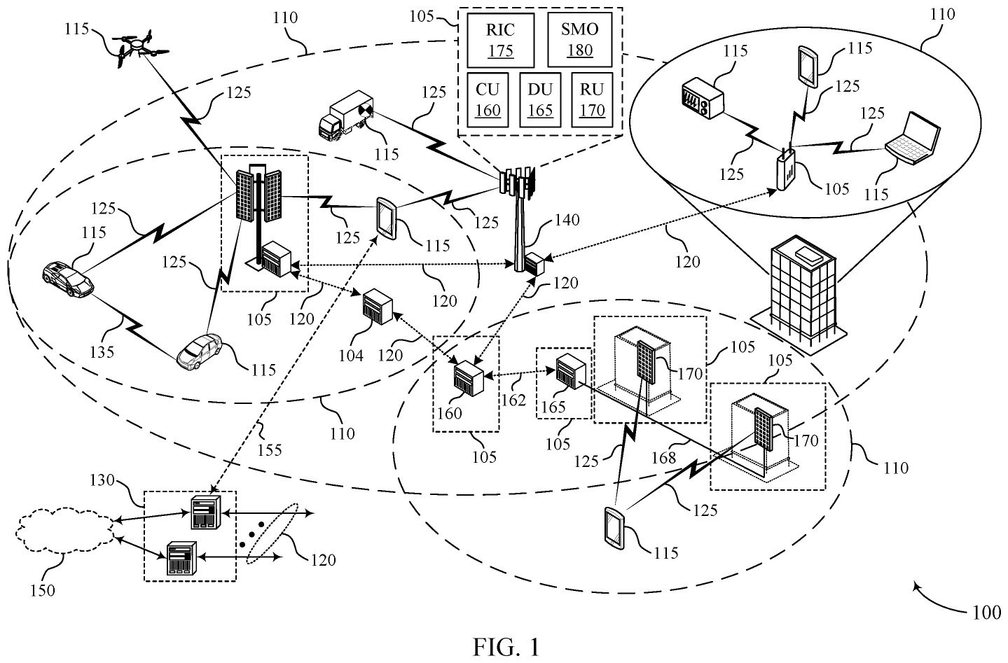

FIG. 1 shows an example of a wireless communications system 100 that supports signaling of sensor specific raw image mask in accordance with one or more examples as disclosed herein. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c. F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support signaling of sensor specific raw image mask as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking. Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A first device (e.g., a UE 115, a sensor device such as smart glasses) may capture an image that is to be transmitted to a second device (e.g., a UE 115, a network entity 105). The first device may generate a mosaic image using a color field array (CFA) and may transmit the mosaic image to the second device, which may process the mosaic image, (e.g., through demosaicing or interpolation) to obtain multiple layers of an output image (e.g., where each layer may be associated with a color of the output image, such as red, green, and blue layers for an RGB image). In this way, the processing burden, processing time, and power consumption at the first device may be reduced as the second device performs image processing that would otherwise be performed at the first device.

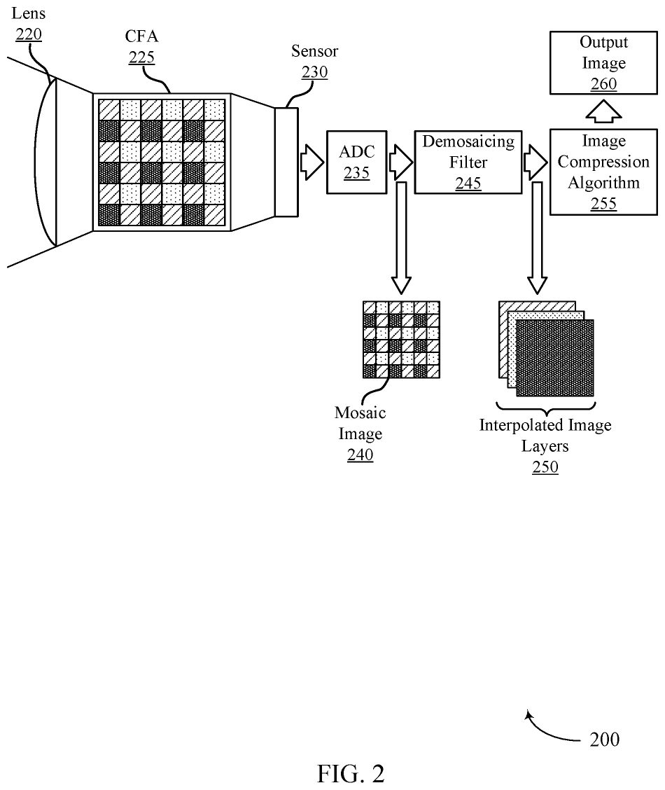

FIG. 2 shows an example of an image communications scheme 200 that supports signaling of sensor specific raw image mask in accordance with one or more examples as disclosed herein.

In consumer, commercial, or industrial electronics, devices frequently capture images. For example, a device may capture still images, video (e.g., which may be formed using a collection of still images), or both. To store such an image may involve substantial amounts of memory. Thus, in order to effectively store the image while taking memory and storage considerations into account, some devices may implement compression algorithms or processes that may decrease image memory consumption.

In some examples, a device capturing images may employ a lens 220, CFA, and a sensor 230 to capture images. For example, a device may capture one or more colors (e.g., Red, Green, Blue (RGB)) of light, whereas another device may capture light at other wavelengths (e.g., infrared wavelengths). In some examples, to reduce cost or complexity, a device may employ the use of a color field array (CFA) (e.g., such as the CFA 225). The CFA 225 may be a physical device or element of the device that is placed after the lens 220 and prior to the sensor 230. For each pixel, the CFA 225 may allow light of a single wavelength, range of wavelengths, or color, thereby producing a “mosaic” image (e.g., the mosaic image 240) where each pixel location contains a sample of a single color (e.g., red, green or blue, in the case of the Bayer filter). The CFA 225 may be configured in various arrangements, which may include a Bayer filter, an RGBE filter, an RYYB filter, a CYYM filter, an RGBW filter, one or more other filters or CFAs, or any combination thereof. Thus, different CFAs 225 may result in different mosaic images 240 that may include samples of different wavelengths of light at different pixel locations of the mosaic image 240.

After the image is passed from the sensor 230 to the ADC 235 to sample the image and create the mosaic image 240, the device may apply a demosaicing filter 245 to the mosaic image 240. The demosaicing filter 245 may be used to interpolate color values for each pixel of the image (e.g., based on color values of one or more nearby pixels) and produce the interpolated image layers 250. The interpolated image layers 250 may include or may be a collection of layers, where each layer includes values for a color. For example, the interpolated image layers 250 may include a red layer, a green layer, and a blue layer (e.g., if the output image is to be an RGB image. matrix of overall RGB image). Each layer may have a same quantity of values (e.g., for a 256×256 image, each layer may have 65,536 values).

From a theoretical standpoint, interpolating the data (e.g., generating the interpolated image layers 250) may not involve any information theoretic value and may be compressed to zero. As such, other approaches in which such processing is performed at a transmitting device may include redundant or unnecessary steps that unnecessarily increase the processing power involved at the transmitting side. For example, the transmitting device may be extended reality (XR) goggles that may involve low power consumption or may be lightweight. Thus, reducing the processing and memory involved at the transmitting side and moving them to the receiving side may be beneficial.

In some approaches, a transmitting device may generate a multiple layer image (e.g., an RGB image or an interpolated image) and may compress the interpolated image to generate an output image 260 to be transmitted across a wireless channel to a receiving device. Such a transmitting device may implement an image compression algorithm 255 (e.g., a video compression algorithm) on an interpolated image and may transmit the image or images to a receiving device. For example, the transmitting device may receive light through a lens, CFA, and a sensor that may form a stream of images (e.g., received at a rate, such as frames per second) and such images may be interpolated into a multi-layer or interpolated image. The transmitting device may perform image compression, video compression, or both, on the stream of images and may transmit the compressed stream of images to a receiving device. In such approaches, the transmitting device may store (e.g., in a buffer) large quantities of data (e.g., a quantity of frames). The receiving device may receive the compressed stream of images and perform image decompression to reconstruct the output multi-layer or interpolated image.

However, as described herein, such approaches may be improved in one or more ways, as such approaches may involve relatively high processing, memory usage, or other considerations at the transmitting device, which may conflict with a use case, configuration, or capability of such a transmitting device.

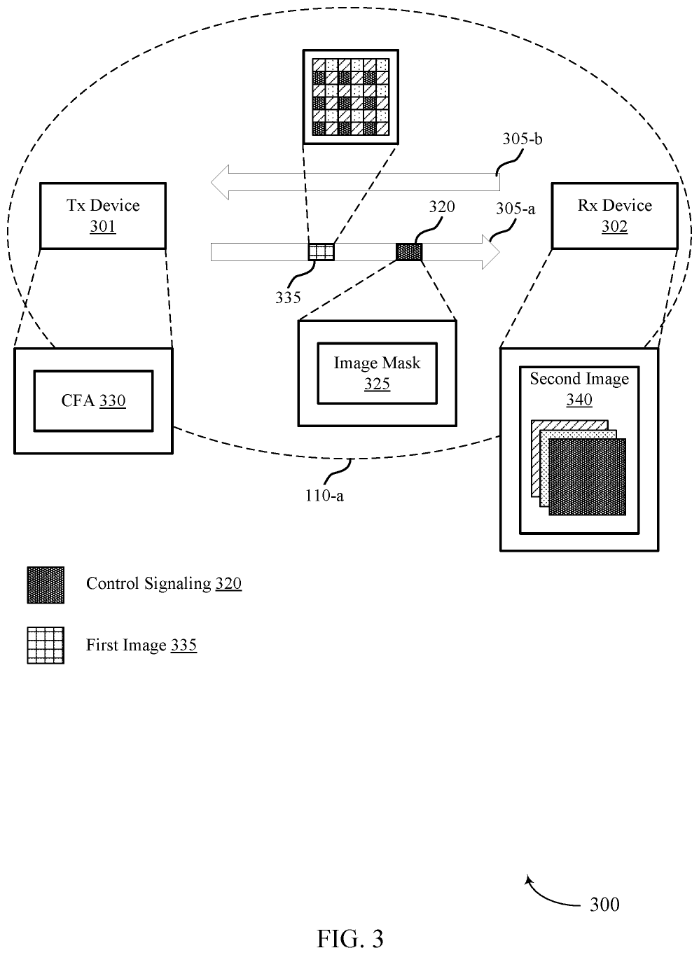

FIG. 3 shows an example of a wireless communications system 300 that supports signaling of sensor specific raw image mask in accordance with one or more examples as disclosed herein. The wireless communications system 300 may include a transmitting (Tx) device 301 and a receiving (Rx) device 302 that may be examples of one or more network entities, one or more UEs, one or more auxiliary devices, or any combination thereof. In some examples, the transmitting device 301, the receiving device 302, or both, may be located in a geographic coverage area 110-a that may be associated with one or more wireless communications devices. The transmitting device 301 and receiving device 302 may communicate via one or more communication links 305-a and one or more communication links 305-b. Though the example of the transmitting device 301 and the receiving device 302 is used here, the same concepts described throughout (including descriptions associated with other figures) may be applied to any quantity of any devices communicating via wireless or wired communications.

In some examples, the transmitting device 301 may transmit control signaling 320 to the receiving device 302. The control signaling 320 may indicate an image mask 325 that the transmitting device 301 may use in connection with image processing at the transmitting device 301. For example, the transmitting device 301 may use the image mask 325 to generate mosaic images as described herein. In some examples, the image mask 325 may be associated with a CFA 330 that may be used to generate mosaic images. The image mask 325 may indicate a pattern of colors used to generate the mosaic image and which may form a basis for interpolating multiple color values at each pixel of an output image, as described herein. In some examples, the control signaling 320 may include one or more sensor-dependent parameters, CFA-dependent parameters, other hardware-dependent parameters, or any combination thereof that the transmitting device 301 may use to generate the first image 335. In some examples, the control signaling 320 may be transmitted in response to establishing a connection between the transmitting device 301 and the receiving device 302. In some examples, the control signaling may be transmitted or received in accordance with one or more other periodicities. For example, the control signaling 320 may be downlink control information signaling, uplink control information signaling, sidelink control information signaling, other control signaling, or any combination thereof, and may be transmitted or received in accordance with periodicities or events associated with such control signaling.

In some examples, the transmitting device 301 may transmit the first image 335 to the receiving device 302. The first image 335 may be a mosaic image as described herein. For example, the first image 335 may be a single layer image that includes a mosaic pattern that may be based on or in accordance with the CFA 330 used at the transmitting device 301.

In some examples, the receiving device 302 may generate the second image 340 based on the first image 335 and the image mask 325. The second image 340 may be an image including multiple layers (e.g., a layer each for different colors, such as in an RGB image that includes layers for red, green, and blue). The receiving device 302 may generate the second image 340 through an interpolation or “demosaicing” process. Such a process may use values of a first color from pixels of the first image 335 to interpolate color values (e.g., to be included in a layer of the second image 340) for nearby pixels that did not include a color value for the first color in the first image 335. In some cases, the second image 340 may include a same quantity of pixels as the first image 335 (e.g., the second image 340 may include values for each of multiple colors for each pixel of the first image 335). In other cases, demosaicing may decimate the first image 335 by some factor. For example, the second image 340 may include one set of values (e.g., R, G, B values) for each of a quantity (e.g., 1.5, 2, 3, 4) of pixels of the first image 335.

In this way, the processing, memory, complexity, latency, and capability burdens on the transmitting device 301 may be reduced, as the transmitting device 301 may transmit the first image 335 to the receiving device 302 and the receiving device 302 may perform the processing to generate the second image 340 (e.g., instead of the transmitting device 301).

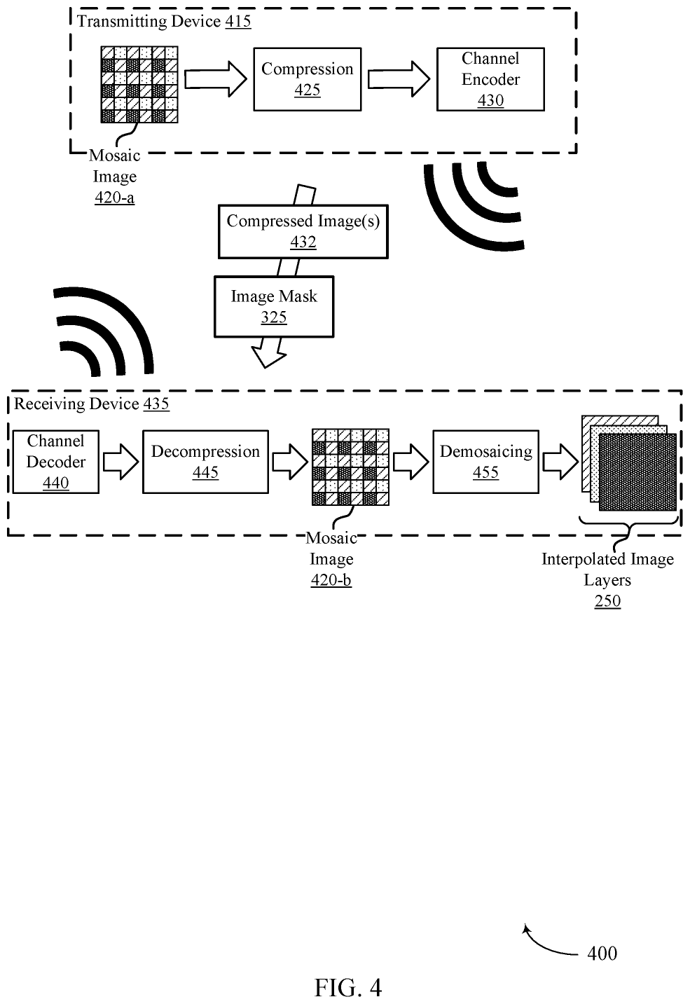

FIG. 4 shows an example of an image communications scheme 400 that supports signaling of sensor specific raw image mask in accordance with one or more examples as disclosed herein.

In some examples, to reduce the overall power consumption associated with image compression, video compression, or both, the receiving device 435 may perform the interpolation or “demosaicing” processing (e.g., instead of the transmitting device). Further, additional signaling (e.g., as described herein) may be employed to support the processing (e.g., the interpolation or demosaicing) at the receiving device 435.

For example, the transmitting device 415 may transmit an image mask 325 (or information associated with the image mask 325, such as an index associated with the image mask 325 that the receiving device 435 may use to identify the image mask 325) associated with the sensor, CFA, or both used at the transmitting device 415. As different hardware manufacturers may implement different CFAs, sensors, “demosaicing” algorithms, or any combination thereof, the receiving device 435 may receiving signaling to indicate the different CFAs, sensors, demosaicing algorithms, or any combination thereof that are to be used by the transmitting device 415.

In some examples, the transmitting device 415 may pass the mosaic image 420-a through compression 425. Thus, due to the use of the mosaic image 420-a, the compression 425, or both, memory usage may be reduced (e.g., by occupying less image size by factor of 3, for example). The transmitting device 415 may pass the compressed image through the channel encoder 430 and transmit the compressed image 432 to the receiving device 435.

The receiving device 435 may receive a stream of compressed images 432 (e.g., which may be arranged or indicated as being frames at a rate, such as at a rate of X frames per second) directly from the transmitting device 415 as mosaic images (e.g., unlike other approaches involving transmission of already interpolated images). Thus, the receiving device 435 may pass the received compressed image 432 through the channel decoder 440 and the decompression 445 to obtain the mosaic image 420-b. The receiving device 435 may then apply demosaicing 455 (e.g., interpolation) to generate the interpolated image layers 250, which may be combined or interpreted as an output image (e.g., an RGB image or other image including multiple layers and colors).

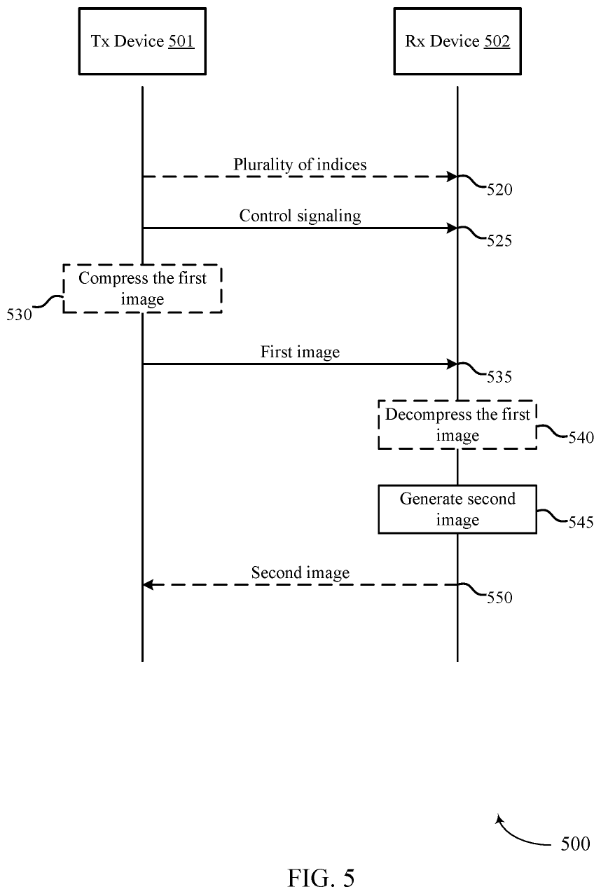

FIG. 5 shows an example of a process flow 500 that supports signaling of sensor specific raw image mask in accordance with one or more examples as disclosed herein.

The process flow 500 may implement various aspects of the present disclosure described herein. The elements described in the process flow 500 (e.g., the transmitting device 501 and the receiving device 502) may be examples of similarly named elements described herein.

In the following description of the process flow 500, the operations between the various entities or elements may be performed in different orders or at different times. Some operations may also be left out of the process flow 500, or other operations may be added. Although the various entities or elements are shown performing the operations of the process flow 500, some aspects of some operations may also be performed by other entities or elements of the process flow 500 or by entities or elements that are not depicted in the process flow, or any combination thereof.

At 520, the receiving device 502 may receive an indication of the plurality of indices associated with the plurality of color filter arrays.

At 525, the receiving device 502 may receive control signaling from a transmitting device 501, the control signaling indicating an image mask representing a color filter array that is used to generate mosaic images at the transmitting device 501. In some examples, receiving the control signaling includes receiving a pattern of colors associated with the color filter array. In some examples, receiving the control signaling indicating the image mask may include receiving an index associated with the color filter array selected from a plurality of indices associated with a plurality of color filter arrays. In some examples, the control signaling is received in response to establishing a connection between the transmitting device 501 and the receiving device 502. In some examples, the control signaling is radio resource control (RRC) signaling, uplink control information (UCI) signaling, downlink control information (DCI) signaling, sidelink control information (SCI) signaling, or any combination thereof.

The transmitting device 501 may obtain a first image. For example, the transmitting device 501 may capture the image data using an image sensor (e.g., with a CFA). At 530, the transmitting device 501 may optionally compress the first image. In some cases, the compression of the first image may be based on the mosaic pattern of the CFA. For example, the compression may compress values associated with each color of the CFA separately. However, the compression may not perform interpolation, such that the first image may have color values that represent locations in the image that are spatially offset from each other, and may have different quantities of pixel values for each of multiple colors of the CFA. For example, for a Bayer filter, there may be twice as many values associated with the green filters as the red or blue filters.

At 535, the transmitting device 501 may transmit the first image over a wireless communications channel, and the receiving device 502 may receive the first image. The first image may be transmitted as a series of one or more transport blocks, where the image data (e.g., values representing colors of the mosaic pattern) in the transport blocks may be the image data captured by the sensor, or the compressed image data. The first image may be a single layer image that may represent values of a mosaic pattern according to the color filter array. In some examples, the first image is a single layer image.

At 540, the first image may be a compressed image, and the receiving device 502 may decompress the first image.

At 545, the receiving device 502 may generate a second image based on the first image and the image mask and the second image may include multiple layers associated with colors of the second image. In some examples, generating the second image may include applying, to the first image, a demosaicing filter that corresponds to the image mask to interpolate multiple layers of the second image from the first image. Thus, the second image may have multiple values corresponding to different colors for each of a quantity of pixel locations (e.g., the different color values may be spatially aligned). In some examples, the second image is generated at a physical layer of the receiving device 502, or at a layer below an application layer (e.g., at an RLC layer, at a PDCP layer).

In some cases, the transmitting device 501 may also have image display capabilities (e.g., XR goggles). At 550, the receiving device 502 may transmit, to the transmitting device 501, the second image. In some examples, the second image is an image generated based on the first image and the image mask, and the second image that may include multiple layers associated with colors of the second image.

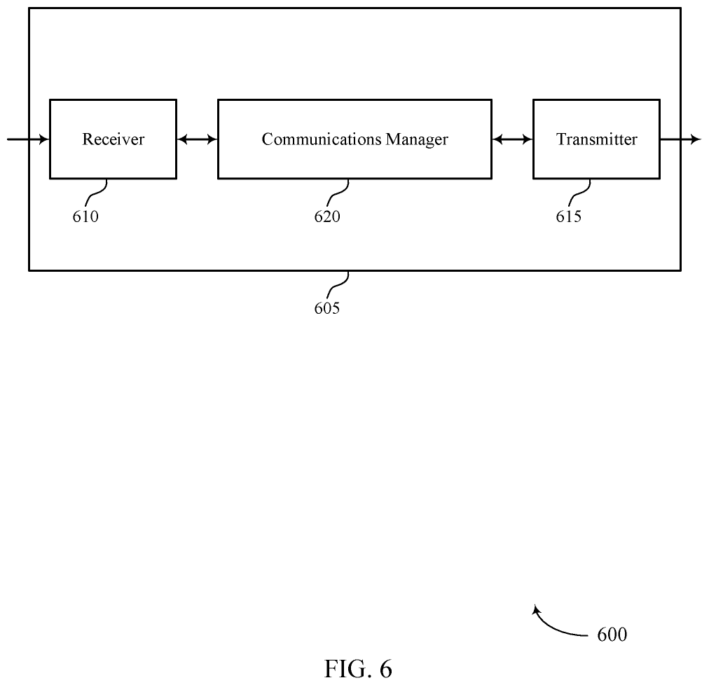

FIG. 6 shows a block diagram 600 of a device 605 that supports signaling of sensor specific raw image mask in accordance with one or more examples as disclosed herein. The device 605 may be an example of aspects of a network entity 105 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The communications manager 620, the receiver 610, the transmitter 615, or various combinations thereof or various components thereof may be examples of means for performing various aspects of signaling of sensor specific raw image mask as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting. individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

Additionally, or alternatively, the communications manager 620 may support wireless communications in accordance with examples as disclosed herein. For example, the communications manager 620 is capable of, configured to, or operable to support a means for receiving, at a first network entity, control signaling from a second network entity, the control signaling indicating an image mask representing a color filter array that is used to generate mosaic images at the second network entity. The communications manager 620 is capable of, configured to, or operable to support a means for receiving a first image at the first network entity from the second network entity over a wireless communications channel, where the first image is a single layer image including a mosaic pattern according to the color filter array. The communications manager 620 is capable of, configured to, or operable to support a means for generating, at the first network entity, a second image based on the first image and the image mask, where the second image includes multiple layers associated with colors of the second image.

Additionally, or alternatively, the communications manager 620 may support wireless communications in accordance with examples as disclosed herein. For example, the communications manager 620 is capable of, configured to, or operable to support a means for transmitting, from a first network entity to a second network entity, control signaling indicating an image mask representing a color filter array that is used to generate mosaic images at the first network entity. The communications manager 620 is capable of, configured to, or operable to support a means for transmitting a first image from the first network entity to the second network entity over a wireless communications channel, where the first image is a single layer image including a mosaic pattern according to the color filter array.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, more efficient utilization of communication resources, or any combination thereof.

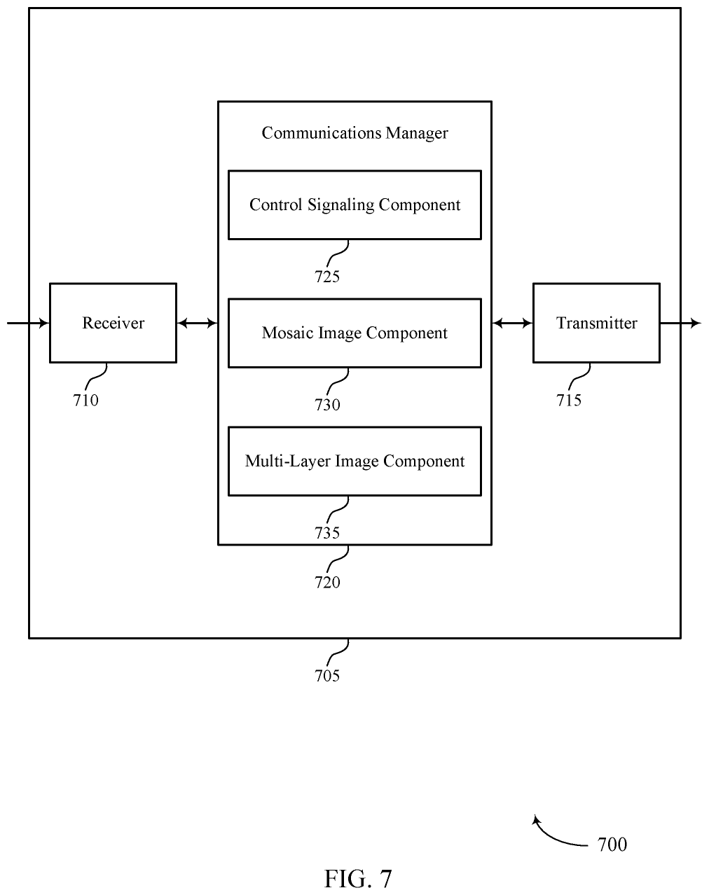

FIG. 7 shows a block diagram 700 of a device 705 that supports signaling of sensor specific raw image mask in accordance with one or more examples as disclosed herein. The device 705 may be an example of aspects of a device 605 or a network entity 105 as described herein. The device 705 may include a receiver 710, a transmitter 715, and a communications manager 720. The device 705, or one of more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The device 705, or various components thereof, may be an example of means for performing various aspects of signaling of sensor specific raw image mask as described herein. For example, the communications manager 720 may include a control signaling component 725, a mosaic image component 730, a multi-layer image component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The control signaling component 725 is capable of, configured to, or operable to support a means for receiving, at a first network entity, control signaling from a second network entity, the control signaling indicating an image mask representing a color filter array that is used to generate mosaic images at the second network entity. The mosaic image component 730 is capable of, configured to, or operable to support a means for receiving a first image at the first network entity from the second network entity over a wireless communications channel, where the first image is a single layer image including a mosaic pattern according to the color filter array. The multi-layer image component 735 is capable of, configured to, or operable to support a means for generating, at the first network entity, a second image based on the first image and the image mask, where the second image includes multiple layers associated with colors of the second image.

Additionally, or alternatively, the communications manager 720 may support wireless communications in accordance with examples as disclosed herein. The control signaling component 725 is capable of, configured to, or operable to support a means for transmitting, from a first network entity to a second network entity, control signaling indicating an image mask representing a color filter array that is used to generate mosaic images at the first network entity. The mosaic image component 730 is capable of, configured to, or operable to support a means for transmitting a first image from the first network entity to the second network entity over a wireless communications channel, where the first image is a single layer image including a mosaic pattern according to the color filter array.

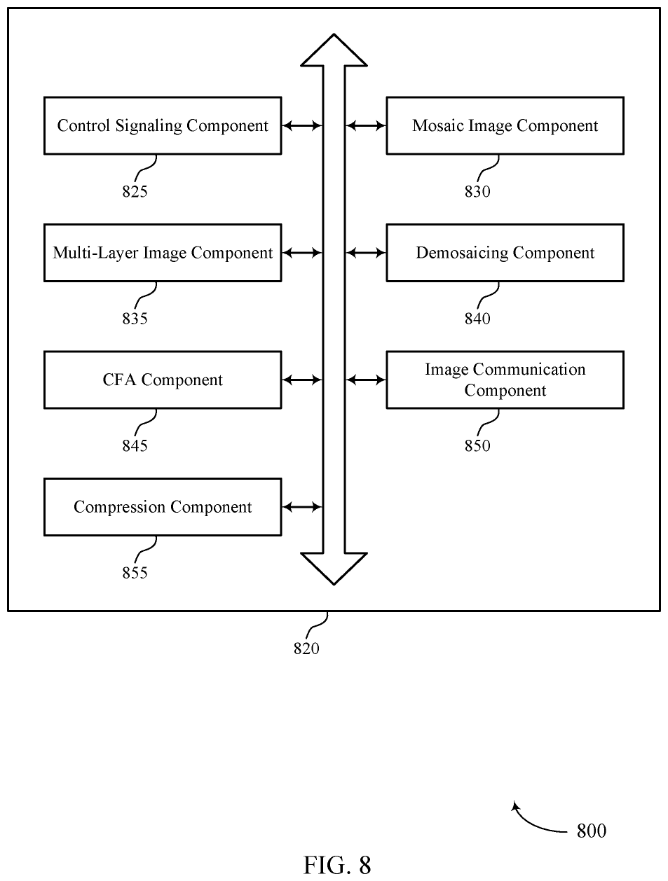

FIG. 8 shows a block diagram 800 of a communications manager 820 that supports signaling of sensor specific raw image mask in accordance with one or more examples as disclosed herein. The communications manager 820 may be an example of aspects of a communications manager 620, a communications manager 720, or both, as described herein. The communications manager 820, or various components thereof, may be an example of means for performing various aspects of signaling of sensor specific raw image mask as described herein. For example, the communications manager 820 may include a control signaling component 825, a mosaic image component 830, a multi-layer image component 835, a demosaicing component 840, a CFA component 845, an image communication component 850, a compression component 855, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

Additionally, or alternatively, the communications manager 820 may support wireless communications in accordance with examples as disclosed herein. The control signaling component 825 is capable of, configured to, or operable to support a means for receiving, at a first network entity, control signaling from a second network entity, the control signaling indicating an image mask representing a color filter array that is used to generate mosaic images at the second network entity. The mosaic image component 830 is capable of, configured to, or operable to support a means for receiving a first image at the first network entity from the second network entity over a wireless communications channel, where the first image is a single layer image including a mosaic pattern according to the color filter array. The multi-layer image component 835 is capable of, configured to, or operable to support a means for generating, at the first network entity, a second image based on the first image and the image mask, where the second image includes multiple layers associated with colors of the second image.

In some examples, generating the second image includes applying, to the first image, a demosaicing filter that corresponds to the image mask to interpolate multiple layers of the second image from the first image.

In some examples, the second image is generated at a physical layer of the first network entity.

In some examples, the CFA component 845 is capable of, configured to, or operable to support a means for receiving the control signaling indicating the image mask includes receiving a pattern of colors associated with the color filter array.

In some examples, receiving the control signaling indicating the image mask includes receiving an index associated with the color filter array selected from a set of multiple indices associated with a set of multiple color filter arrays.

In some examples, the CFA component 845 is capable of, configured to, or operable to support a means for receiving an indication of the set of multiple indices associated with the set of multiple color filter arrays.

In some examples, the image communication component 850 is capable of, configured to, or operable to support a means for transmitting, to the second network entity, the second image or a second mosaic image based on the second image.

In some examples, the first image is a compressed image; the method further including decompressing the first image at the first network entity.

In some examples, the control signaling is received in response to establishing a connection between the first network entity and the second network entity.

In some examples, the first image is a single layer image.

In some examples, the control signaling is RRC signaling, uplink control information (UCI) signaling, DCI signaling, sidelink control information (SCI) signaling, or any combination thereof.

Additionally, or alternatively, the communications manager 820 may support wireless communications in accordance with examples as disclosed herein. In some examples, the control signaling component 825 is capable of, configured to, or operable to support a means for transmitting, from a first network entity to a second network entity, control signaling indicating an image mask representing a color filter array that is used to generate mosaic images at the first network entity. In some examples, the mosaic image component 830 is capable of, configured to, or operable to support a means for transmitting a first image from the first network entity to the second network entity over a wireless communications channel, where the first image is a single layer image including a mosaic pattern according to the color filter array.

In some examples, the CFA component 845 is capable of, configured to, or operable to support a means for transmitting the control signaling indicating the image mask includes transmitting a pattern of colors associated with the color filter array.

In some examples, transmitting the control signaling indicating the image mask includes transmitting an index associated with the color filter array selected from a set of multiple indices associated with a set of multiple color filter arrays.

In some examples, the CFA component 845 is capable of, configured to, or operable to support a means for transmitting an indication of the set of multiple indices associated with the set of multiple color filter arrays.

In some examples, the image communication component 850 is capable of, configured to, or operable to support a means for receiving a second image from the second network entity, the second image generated based on the first image and the image mask, and the second image including multiple layers associated with colors of the second image or a second mosaic image.

In some examples, the compression component 855 is capable of, configured to, or operable to support a means for compressing the first image.

In some examples, the control signaling is transmitted in response to establishing a connection between the first network entity and the second network entity.

In some examples, the first image is a single layer image.

In some examples, the control signaling is RRC signaling, uplink control information signaling, downlink control information signaling, sidelink control information signaling, or any combination there.

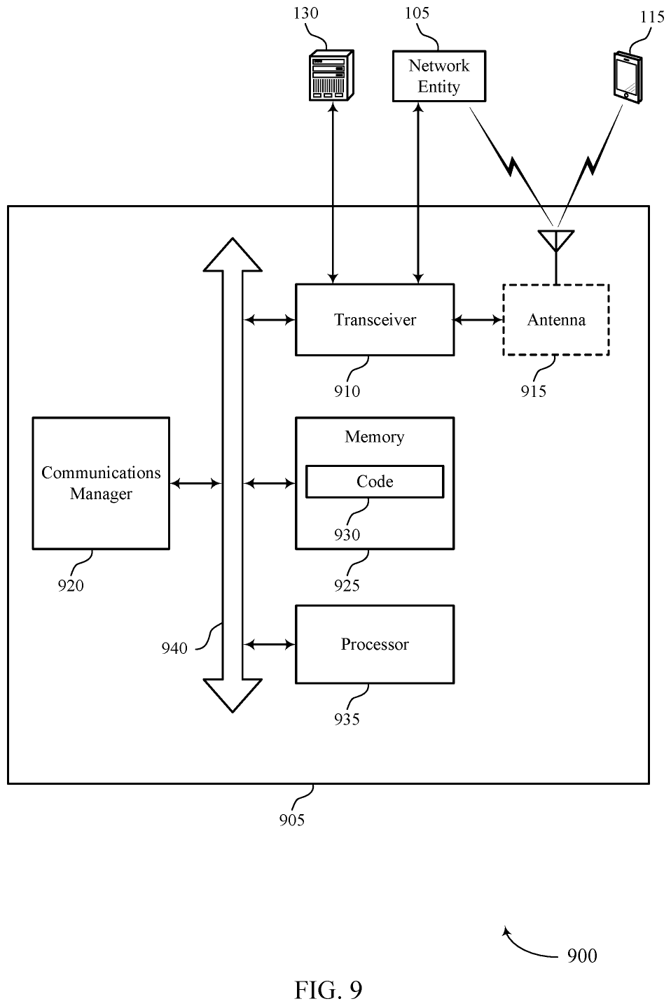

FIG. 9 shows a diagram of a system 900 including a device 905 that supports signaling of sensor specific raw image mask in accordance with one or more examples as disclosed herein. The device 905 may be an example of or include the components of a device 605, a device 705, or a network entity 105 as described herein. The device 905 may communicate with one or more network entities 105, one or more UEs 115, or any combination thereof, which may include communications over one or more wired interfaces, over one or more wireless interfaces, or any combination thereof. The device 905 may include components that support outputting and obtaining communications, such as a communications manager 920, a transceiver 910, an antenna 915, at least one memory 925, code 930, and at least one processor 935. These components may be in electronic communication or otherwise coupled (e.g., operatively, communicatively, functionally, electronically, electrically) via one or more buses (e.g., a bus 940).

The transceiver 910 may support bi-directional communications via wired links, wireless links, or both as described herein. In some examples, the transceiver 910 may include a wired transceiver and may communicate bi-directionally with another wired transceiver. Additionally, or alternatively, in some examples, the transceiver 910 may include a wireless transceiver and may communicate bi-directionally with another wireless transceiver. In some examples, the device 905 may include one or more antennas 915, which may be capable of transmitting or receiving wireless transmissions (e.g., concurrently). The transceiver 910 may also include a modem to modulate signals, to provide the modulated signals for transmission (e.g., by one or more antennas 915, by a wired transmitter), to receive modulated signals (e.g., from one or more antennas 915, from a wired receiver), and to demodulate signals. In some implementations, the transceiver 910 may include one or more interfaces, such as one or more interfaces coupled with the one or more antennas 915 that are configured to support various receiving or obtaining operations, or one or more interfaces coupled with the one or more antennas 915 that are configured to support various transmitting or outputting operations, or a combination thereof. In some implementations, the transceiver 910 may include or be configured for coupling with one or more processors or one or more memory components that are operable to perform or support operations based on received or obtained information or signals, or to generate information or other signals for transmission or other outputting, or any combination thereof. In some implementations, the transceiver 910, or the transceiver 910 and the one or more antennas 915, or the transceiver 910 and the one or more antennas 915 and one or more processors or one or more memory components (e.g., the at least one processor 935, the at least one memory 925, or both), may be included in a chip or chip assembly that is installed in the device 905. In some examples, the transceiver 910 may be operable to support communications via one or more communications links (e.g., a communication link 125, a backhaul communication link 120, a midhaul communication link 162, a fronthaul communication link 168).

The at least one memory 925 may include RAM, ROM, or any combination thereof. The at least one memory 925 may store computer-readable, computer-executable code 930 including instructions that, when executed by one or more of the at least one processor 935, cause the device 905 to perform various functions described herein. The code 930 may be stored in a non-transitory computer-readable medium such as system memory or another type of memory. In some cases, the code 930 may not be directly executable by a processor of the at least one processor 935 but may cause a computer (e.g., when compiled and executed) to perform functions described herein. In some cases, the at least one memory 925 may contain, among other things, a BIOS which may control basic hardware or software operation such as the interaction with peripheral components or devices. In some examples, the at least one processor 935 may include multiple processors and the at least one memory 925 may include multiple memories. One or more of the multiple processors may be coupled with one or more of the multiple memories which may, individually or collectively, be configured to perform various functions herein (for example, as part of a processing system).

The at least one processor 935 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 935 may be configured to operate a memory array using a memory controller. In some other cases, a memory controller may be integrated into one or more of the at least one processor 935. The at least one processor 935 may be configured to execute computer-readable instructions stored in a memory (e.g., one or more of the at least one memory 925) to cause the device 905 to perform various functions (e.g., functions or tasks supporting signaling of sensor specific raw image mask). For example, the device 905 or a component of the device 905 may include at least one processor 935 and at least one memory 925 coupled with one or more of the at least one processor 935, the at least one processor 935 and the at least one memory 925 configured to perform various functions described herein. The at least one processor 935 may be an example of a cloud-computing platform (e.g., one or more physical nodes and supporting software such as operating systems, virtual machines, or container instances) that may host the functions (e.g., by executing code 930) to perform the functions of the device 905. The at least one processor 935 may be any one or more suitable processors capable of executing scripts or instructions of one or more software programs stored in the device 905 (such as within one or more of the at least one memory 925). In some examples, the at least one processor 935 may include multiple processors and the at least one memory 925 may include multiple memories. One or more of the multiple processors may be coupled with one or more of the multiple memories, which may, individually or collectively, be configured to perform various functions herein. In some examples, the at least one processor 935 may be a component of a processing system, which may refer to a system (such as a series) of machines, circuitry (including, for example, one or both of processor circuitry (which may include the at least one processor 935) and memory circuitry (which may include the at least one memory 925)), or components, that receives or obtains inputs and processes the inputs to produce, generate, or obtain a set of outputs. The processing system may be configured to perform one or more of the functions described herein. As such, the at least one processor 935 or a processing system including the at least one processor 935 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 925 or otherwise, to perform one or more of the functions described herein.

In some examples, a bus 940 may support communications of (e.g., within) a protocol layer of a protocol stack. In some examples, a bus 940 may support communications associated with a logical channel of a protocol stack (e.g., between protocol layers of a protocol stack), which may include communications performed within a component of the device 905, or between different components of the device 905 that may be co-located or located in different locations (e.g., where the device 905 may refer to a system in which one or more of the communications manager 920, the transceiver 910, the at least one memory 925, the code 930, and the at least one processor 935 may be located in one of the different components or divided between different components).

In some examples, the communications manager 920 may manage aspects of communications with a core network 130 (e.g., via one or more wired or wireless backhaul links). For example, the communications manager 920 may manage the transfer of data communications for client devices, such as one or more UEs 115. In some examples, the communications manager 920 may manage communications with other network entities 105, and may include a controller or scheduler for controlling communications with UEs 115 in cooperation with other network entities 105. In some examples, the communications manager 920 may support an X2 interface within an LTE/LTE-A wireless communications network technology to provide communication between network entities 105.

Additionally, or alternatively, the communications manager 920 may support wireless communications in accordance with examples as disclosed herein. For example, the communications manager 920 is capable of, configured to, or operable to support a means for receiving, at a first network entity, control signaling from a second network entity, the control signaling indicating an image mask representing a color filter array that is used to generate mosaic images at the second network entity. The communications manager 920 is capable of, configured to, or operable to support a means for receiving a first image at the first network entity from the second network entity over a wireless communications channel, where the first image is a single layer image including a mosaic pattern according to the color filter array. The communications manager 920 is capable of, configured to, or operable to support a means for generating, at the first network entity, a second image based on the first image and the image mask, where the second image includes multiple layers associated with colors of the second image.

Additionally, or alternatively, the communications manager 920 may support wireless communications in accordance with examples as disclosed herein. For example, the communications manager 920 is capable of, configured to, or operable to support a means for transmitting, from a first network entity to a second network entity, control signaling indicating an image mask representing a color filter array that is used to generate mosaic images at the first network entity. The communications manager 920 is capable of, configured to, or operable to support a means for transmitting a first image from the first network entity to the second network entity over a wireless communications channel, where the first image is a single layer image including a mosaic pattern according to the color filter array.

By including or configuring the communications manager 920 in accordance with examples as described herein, the device 905 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 920 may be configured to perform various operations (e.g., receiving, obtaining, monitoring, outputting, transmitting) using or otherwise in cooperation with the transceiver 910, the one or more antennas 915 (e.g., where applicable), or any combination thereof. Although the communications manager 920 is illustrated as a separate component, in some examples, one or more functions described with reference to the communications manager 920 may be supported by or performed by the transceiver 910, one or more of the at least one processor 935, one or more of the at least one memory 925, the code 930, or any combination thereof (for example, by a processing system including at least a portion of the at least one processor 935, the at least one memory 925, the code 930, or any combination thereof). For example, the code 930 may include instructions executable by one or more of the at least one processor 935 to cause the device 905 to perform various aspects of signaling of sensor specific raw image mask as described herein, or the at least one processor 935 and the at least one memory 925 may be otherwise configured to, individually or collectively, perform or support such operations.

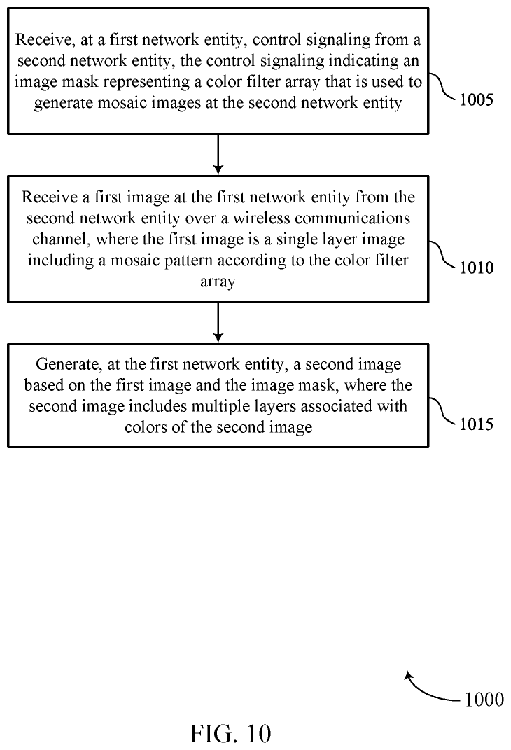

FIG. 10 shows a flowchart illustrating a method 1000 that supports signaling of sensor specific raw image mask in accordance with examples as disclosed herein. The operations of the method 1000 may be implemented by a network entity or its components as described herein. For example, the operations of the method 1000 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1005, the method may include receiving, at a first network entity, control signaling from a second network entity, the control signaling indicating an image mask representing a color filter array that is used to generate mosaic images at the second network entity. The operations of block 1005 may be performed in accordance with examples as disclosed herein. In some examples, aspects of the operations of 1005 may be performed by a control signaling component 825 as described with reference to FIG. 8.

At 1010, the method may include receiving a first image at the first network entity from the second network entity over a wireless communications channel, where the first image is a single layer image including a mosaic pattern according to the color filter array. The operations of block 1010 may be performed in accordance with examples as disclosed herein. In some examples, aspects of the operations of 1010 may be performed by a mosaic image component 830 as described with reference to FIG. 8.

At 1015, the method may include generating, at the first network entity, a second image based on the first image and the image mask, where the second image includes multiple layers associated with colors of the second image. The operations of block 1015 may be performed in accordance with examples as disclosed herein. In some examples, aspects of the operations of 1015 may be performed by a multi-layer image component 835 as described with reference to FIG. 8.

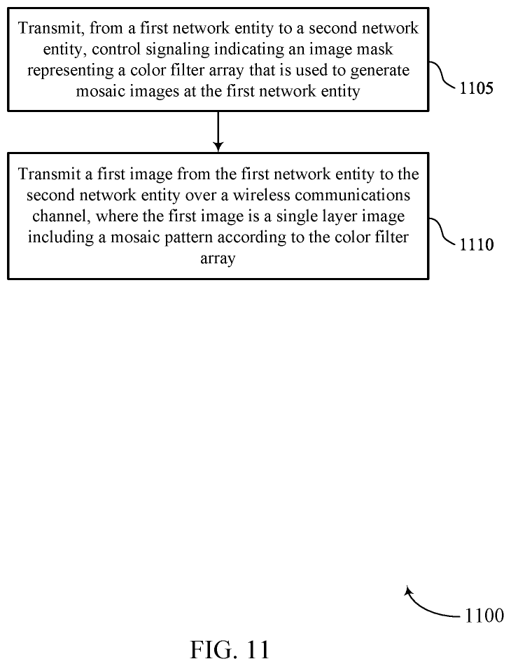

FIG. 11 shows a flowchart illustrating a method 1100 that supports signaling of sensor specific raw image mask in accordance with examples as disclosed herein. The operations of the method 1100 may be implemented by a network entity or its components as described herein. For example, the operations of the method 1100 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1105, the method may include transmitting, from a first network entity to a second network entity, control signaling indicating an image mask representing a color filter array that is used to generate mosaic images at the first network entity. The operations of block 1105 may be performed in accordance with examples as disclosed herein. In some examples, aspects of the operations of 1105 may be performed by a control signaling component 825 as described with reference to FIG. 8.

At 1110, the method may include transmitting a first image from the first network entity to the second network entity over a wireless communications channel, where the first image is a single layer image including a mosaic pattern according to the color filter array. The operations of block 1110 may be performed in accordance with examples as disclosed herein. In some examples, aspects of the operations of 1110 may be performed by a mosaic image component 830 as described with reference to FIG. 8.

The following provides an overview of aspects of the present disclosure:
Aspect 1: A method for wireless communications, comprising: receiving, at a first network entity, control signaling from a second network entity, the control signaling indicating an image mask representing a color filter array that is used to generate mosaic images at the second network entity; receiving a first image at the first network entity from the second network entity over a wireless communications channel, wherein the first image is a single layer image comprising a mosaic pattern according to the color filter array; and generating, at the first network entity, a second image based at least in part on the first image and the image mask, wherein the second image comprises multiple layers associated with colors of the second image.
Aspect 2: The method of aspect 1, wherein generating the second image comprises applying, to the first image, a demosaicing filter that corresponds to the image mask to interpolate multiple layers of the second image from the first image.
Aspect 3: The method of aspect 2, wherein the second image is generated at a physical layer of the first network entity.
Aspect 4: The method of any of aspects 1 through 3, further comprising: receiving the control signaling indicating the image mask comprises receiving a pattern of colors associated with the color filter array.
Aspect 5: The method of any of aspects 1 through 4, wherein receiving the control signaling indicating the image mask comprises receiving an index associated with the color filter array selected from a plurality of indices associated with a plurality of color filter arrays.
Aspect 6: The method of aspect 5, further comprising: receiving an indication of the plurality of indices associated with the plurality of color filter arrays.
Aspect 7: The method of any of aspects 1 through 6, further comprising: transmitting, to the second network entity, the second image or a second mosaic image based on the second image.
Aspect 8: The method of any of aspects 1 through 7, wherein the first image is a compressed image; the method further comprising decompressing the first image at the first network entity.
Aspect 9: The method of any of aspects 1 through 8, wherein the control signaling is received in response to establishing a connection between the first network entity and the second network entity.
Aspect 10: The method of any of aspects 1 through 9, wherein the first image is a single layer image.
Aspect 11: The method of any of aspects 1 through 10, wherein the control signaling is RRC signaling, uplink control information (UCI) signaling, DCI signaling, sidelink control information (SCI) signaling, or any combination thereof.
Aspect 12: A method for wireless communications, comprising: transmitting, from a first network entity to a second network entity, control signaling indicating an image mask representing a color filter array that is used to generate mosaic images at the first network entity; and transmitting a first image from the first network entity to the second network entity over a wireless communications channel, wherein the first image is a single layer image comprising a mosaic pattern according to the color filter array.
Aspect 13: The method of aspect 12, further comprising: transmitting the control signaling indicating the image mask comprises transmitting a pattern of colors associated with the color filter array.
Aspect 14: The method of any of aspects 12 through 13, wherein transmitting the control signaling indicating the image mask comprises transmitting an index associated with the color filter array selected from a plurality of indices associated with a plurality of color filter arrays.
Aspect 15: The method of aspect 14, further comprising: transmitting an indication of the plurality of indices associated with the plurality of color filter arrays.
Aspect 16: The method of any of aspects 12 through 15, further comprising: receiving a second image from the second network entity, the second image generated based at least in part on the first image and the image mask, and the second image comprising multiple layers associated with colors of the second image or a second mosaic image.
Aspect 17: The method of any of aspects 12 through 16, further comprising: compressing the first image.
Aspect 18: The method of any of aspects 12 through 17, wherein the control signaling is transmitted in response to establishing a connection between the first network entity and the second network entity.
Aspect 19: The method of any of aspects 12 through 18, wherein the first image is a single layer image.
Aspect 20: The method of any of aspects 12 through 19, wherein the control signaling is RRC signaling, uplink control information signaling, downlink control information signaling, sidelink control information signaling, or any combination there.
Aspect 21: An apparatus for wireless communications, comprising one or more memories storing processor-executable code, and one or more processors coupled with the one or more memories and individually or collectively operable to execute the code to cause the apparatus to perform a method of any of aspects 1 through 11.
Aspect 22: An apparatus for wireless communications, comprising at least one means for performing a method of any of aspects 1 through 11.
Aspect 23: A non-transitory computer-readable medium storing code for wireless communications, the code comprising instructions executable by a processor to perform a method of any of aspects 1 through 11.
Aspect 24: An apparatus for wireless communications, comprising one or more memories storing processor-executable code, and one or more processors coupled with the one or more memories and individually or collectively operable to execute the code to cause the apparatus to perform a method of any of aspects 12 through 20.
Aspect 25: An apparatus for wireless communications, comprising at least one means for performing a method of any of aspects 12 through 20.
Aspect 26: A non-transitory computer-readable medium storing code for wireless communications, the code comprising instructions executable by a processor to perform a method of any of aspects 12 through 20.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network entity, comprising:
one or more memories storing processor-executable code; and
one or more processors coupled with the one or more memories and individually or collectively operable to execute the code to cause the first network entity to:
receive, at the first network entity, control signaling from a second network entity, the control signaling indicating an image mask representing a color filter array that is used to generate mosaic images at the second network entity;
receive a first image at the first network entity from the second network entity over a wireless communications channel, wherein the first image is a single layer image comprising a mosaic pattern according to the color filter array; and
generate, at the first network entity, a second image based at least in part on the first image and the image mask, wherein the second image comprises multiple layers associated with colors of the second image.

2. The first network entity of claim 1, wherein generating the second image comprises applying, to the first image, a demosaicing filter that corresponds to the image mask to interpolate multiple layers of the second image from the first image.

3. The first network entity of claim 2, wherein the second image is generated at a physical layer of the first network entity.

4. The first network entity of claim 1, wherein, to receive the control signaling, the one or more processors are individually or collectively further operable to execute the code to cause the first network entity to:
receive a pattern of colors associated with the color filter array.

5. The first network entity of claim 1, wherein receiving the control signaling indicating the image mask comprises receiving an index associated with the color filter array selected from a plurality of indices associated with a plurality of color filter arrays.

6. The first network entity of claim 5, wherein the one or more processors are individually or collectively further operable to execute the code to cause the first network entity to:
receive an indication of the plurality of indices associated with the plurality of color filter arrays.

7. The first network entity of claim 1, wherein the one or more processors are individually or collectively further operable to execute the code to cause the first network entity to:
transmit, to the second network entity, the second image or a second mosaic image based on the second image.

8. The first network entity of claim 1, wherein:
the first image is a compressed image; and
the one or more processors are individually or collectively further operable to execute the code to cause the first network entity to decompress the first image at the first network entity.

9. The first network entity of claim 1, wherein the control signaling is received in response to establishing a connection between the first network entity and the second network entity.

10. The first network entity of claim 1, wherein the first image is a single layer image.

11. The first network entity of claim 1, wherein the control signaling is radio resource control (RRC) signaling, uplink control information (UCI) signaling, downlink control information (DCI) signaling, sidelink control information (SCI) signaling, or any combination thereof.

12. A first network entity, comprising:
one or more memories storing processor-executable code; and
one or more processors coupled with the one or more memories and individually or collectively operable to execute the code to cause the first network entity to:
transmit, from the first network entity to a second network entity, control signaling indicating an image mask representing a color filter array that is used to generate mosaic images at the first network entity; and
transmit a first image from the first network entity to the second network entity over a wireless communications channel, wherein the first image is a single layer image comprising a mosaic pattern according to the color filter array.

13. The first network entity of claim 12, wherein the one or more processors are individually or collectively further operable to execute the code to cause the first network entity to:
transmit the control signaling indicating the image mask comprises transmitting a pattern of colors associated with the color filter array.

14. The first network entity of claim 12, wherein transmitting the control signaling indicating the image mask comprises transmitting an index associated with the color filter array selected from a plurality of indices associated with a plurality of color filter arrays.

15. The first network entity of claim 14, wherein the one or more processors are individually or collectively further operable to execute the code to cause the first network entity to:
transmit an indication of the plurality of indices associated with the plurality of color filter arrays.

16. The first network entity of claim 12, wherein the one or more processors are individually or collectively further operable to execute the code to cause the first network entity to:
receive a second image from the second network entity, the second image generated based at least in part on the first image and the image mask, and the second image comprising multiple layers associated with colors of the second image or a second mosaic image.

17. The first network entity of claim 12, wherein the one or more processors are individually or collectively further operable to execute the code to cause the first network entity to:
compress the first image.

18. The first network entity of claim 12, wherein the control signaling is transmitted in response to establishing a connection between the first network entity and the second network entity.

19. The first network entity of claim 12, wherein the first image is a single layer image.

20. The first network entity of claim 12, wherein the control signaling is radio resource control (RRC) signaling, uplink control information signaling, downlink control information signaling, sidelink control information signaling, or any combination there.

21. A method for wireless communications, comprising:
receiving, at a first network entity, control signaling from a second network entity, the control signaling indicating an image mask representing a color filter array that is used to generate mosaic images at the second network entity;
receiving a first image at the first network entity from the second network entity over a wireless communications channel, wherein the first image is a single layer image comprising a mosaic pattern according to the color filter array; and
generating, at the first network entity, a second image based at least in part on the first image and the image mask, wherein the second image comprises multiple layers associated with colors of the second image.

22. The method of claim 21, wherein generating the second image comprises applying, to the first image, a demosaicing filter that corresponds to the image mask to interpolate multiple layers of the second image from the first image.

23. The method of claim 21, further comprising:
receiving the control signaling indicating the image mask comprises receiving a pattern of colors associated with the color filter array.

24. The method of claim 21, wherein receiving the control signaling indicating the image mask comprises receiving an index associated with the color filter array selected from a plurality of indices associated with a plurality of color filter arrays.

25. The method of claim 21, wherein the first image is a compressed image; the method further comprising decompressing the first image at the first network entity.

26. A method for wireless communications, comprising:
transmitting, from a first network entity to a second network entity, control signaling indicating an image mask representing a color filter array that is used to generate mosaic images at the first network entity; and
transmitting a first image from the first network entity to the second network entity over a wireless communications channel, wherein the first image is a single layer image comprising a mosaic pattern according to the color filter array.

27. The method of claim 26, further comprising:
transmitting the control signaling indicating the image mask comprises transmitting a pattern of colors associated with the color filter array.

28. The method of claim 26, wherein transmitting the control signaling indicating the image mask comprises transmitting an index associated with the color filter array selected from a plurality of indices associated with a plurality of color filter arrays.

29. The method of claim 26, further comprising:
receiving a second image from the second network entity, the second image generated based at least in part on the first image and the image mask, and the second image comprising multiple layers associated with colors of the second image or a second mosaic image.

30. The method of claim 26, wherein the control signaling is transmitted in response to establishing a connection between the first network entity and the second network entity.
